(19) United States
(12) Patent Application Publication
(10) Pub. No.: US 2002/0175862 A1
(43) Pub. Date: Nov. 28, 2002

(54) Antenna array

(75) Inventors: Mark Timothy James Hunter, Saffron Walden (GB); Malcolm John Crisp, Saffron Walden (GB); Nick Moss, Harrow (GB)

Correspondence Address: BEYER WEAVER & THOMAS LLP, P.O. BOX 778, BERKELEY, CA, 94704-0778, US

(73) Assignee: Red-M (Communications) Ltd.

(21) Appl. No.: 10/087,104

(22) Filed: Feb. 28, 2002

(30) Foreign Application Priority Data
Mar. 1, 2001 (EP) 01301884.1

(51) Int. Cl. H01Q 1/38; H01Q 13/10; H01Q 21/00

(52) U.S. Cl. 343/700 MS; 343/770; 343/810

(57) ABSTRACT

An antenna array achieves a high degree of isolation between a plurality of collocated antennas through a combination of electrical polarisation and mechanical alignment. The antenna array consists of three surfaces arranged in mutually orthogonal planes, each surface supporting a planar antenna, wherein each antenna is orthogonally polarised with respect to antenna on other surfaces. Each antenna is linearly polarised to provide a linearly polarised radiation field.

There are a number of types of antenna which may be employed, including linearly polarised dipole or mono-pole antennaes, which can be physically realized, for example, as a wire conductor; a transmission line structure; a radiating slot structure; or a micro-strip patch antenna.

### FIELD OF THE INVENTION

This invention relates to radio antenna structure design, and in particular to means of collocating a number of antennas whilst maintaining a high degree of electrical isolation between each one.

### BACKGROUND TO THE INVENTION

In terrestrial radio communications systems there is often a requirement for covering a geographical area with an array of antennas centrally located within the area, such that each antenna provides coverage to only a segment of the total area. Such coverage segmentation may be required for reasons of sharing the total communication traffic between the antennas or for enabling the use of narrow beam antennas having a high power gain to be employed.

In such communications systems it is generally necessary to ensure a high degree of signal isolation between each antenna in such an array. Signal isolation may be required to reduce the mutual interference which may occur between each transmitter system connected to each antenna; or to reduce the mutual interference which may arise with one or more antennas operating in transmit mode whilst one or more of the other antennas are operating in receive mode.

In a cellular base station, a number of independent radios are collocated and attached to respective antennas pointing in different directions. For example, in a three sector base station each antenna is separated by 120°. Typically, each sector uses a different set of frequencies such that conventional receiver filtering schemes can be used to prevent the reception of unwanted signals. In addition, transmit and receive frequencies for the base station are in different frequency bands.

Orthogonal polarisations are used in microwave point-to-point links. Different signals on the same frequency are sent (or received) on two different polarisations from the same antenna in order to use the frequency allocation in the most efficient manner. The dish antennas used for microwave point-to-point links are high gain and create a narrow beam in a single direction containing both vertical and horizontal polarised signals.

A Bluetooth RF system is a frequency-hopping-spread-spectrum system in which packets are delivered in defined time slots on defined frequencies. A frequency-hopping-system provides interference avoidance, thus allowing a number of devices to operate independently in th4e same area at the same time.

The Bluetooth architecture includes a radio, a baseband link controller, link management protocols, and software. The system can be configured in symmetric mode, for data rates of up to 432.5 Kbps in each direction; asymmetric mode, for packet data rates of 721 Kbps and 57.6 Kbps in two directions; and duplex mode, for 384 Kbps 3G cellular compatibility. In addition, a Bluetooth link can operate three voice channels at 64 Kbps each in circuit-switched mode. The system uses 1 MHz frequency hopping steps to switch among 79 frequencies in the Industrial, Scientific, and Medical (ISM) 2.4 GHz band at 1,600 hops per second, with different hopping sequences used to distinguish different channels. Using small packets and fast hopping limits interference from microwave ovens and other systems operating in this unlicenced radio band, which can be used freely around the world.

Bluetooth operates in something called a piconet, in which several nodes using the same hopping sequence are connected in a point-to-multipoint system. Each piconet can manage as much as 721 Kbps with the master determining how the bandwidth is allocated to the different nodes. As many as 10 piconets of 8 devices each can operate simultaneously, providing a total of approximately 6 Mbps after the overhead is subtracted.

In areas such as airport lounges there may be a requirement to support a large number of Bluetooth enabled devices using a number of access devices distributed in such a manner to provide overlapping coverage. The density of Bluetooth devices may vary considerably across the room. It is necessary to ensure a high degree of signal isolation between antennas in the area of overlap, which requires careful antenna design. Furthermore, the size and cost of the access devices is also an important commercial consideration.

### SUMMARY OF THE INVENTION

According to a first aspect of the present invention, an antenna array comprises three surfaces arranged in mutually orthogonal planes, each surface supporting a planar antenna, wherein each antenna is orthogonally polarised with respect to antenna on other surfaces.

Preferably, each antenna is linearly polarised to provide a linearly polarised radiation field.

The antenna array in the present invention achieves a high degree of isolation between a plurality of collocated antennas through a combination of electrical polarisation and mechanical alignment. The present invention uses the isolation gained from orthogonally polarized antenna elements in three different axes. This is particularly important for Bluetooth applications because antenna isolation is the only method by which it is believed that a number of Bluetooth radios, each in a different piconet, can be successfully collocated. Each antenna element in the design operates independently and sees the other two antenna elements as potential interferers. The advantage of the design is two-fold: The isolation between each element means that three independent Bluetooth radios can be collocated in the array, thus reducing the number of local access devices required; and the unique directional nature of each of the antenna elements (approximately 60° beam width) means that each signal is only transmitted in one direction, thus reducing the level of unwanted interference in other directions and increasing the user density that can be supported.

There are a number of types of antenna which may be employed, including linearly polarised dipole or mono-pole antennae, which can be physically realised, for example, as a wire conductor; a transmission line structure; a radiating slot structure; or a micro-strip patch antenna.

According to a second aspect of the present invention, a radio communications system comprises a plurality of antenna arrays in accordance with the first aspect of the invention that are connected together to form a communications network.

Preferably, each antenna array is configured as a Bluetooth access device.

### BRIEF DESCRIPTION OF THE DRAWINGS

Examples of the present invention will now be described in detail with reference to the accompanying drawings, in which:

FIG. 1 is a simplified schematic view of a first example of an antenna array in accordance with the present invention;

FIGS. 2 to 4 are further examples of an antenna array in accordance with the present invention;

FIGS. 5A and 5B are views of a practical implementation of an antenna array assembly in accordance with the present invention;

FIGS. 6A and 6B illustrate the radiation patterns of the device shown in FIGS. 5A and 5B; and,

FIG. 7 is an example of a room that is provided with a number of antenna arrays in accordance with the present invention to form a Bluetooth enabled communications network.

### DETAILED DESCRIPTION

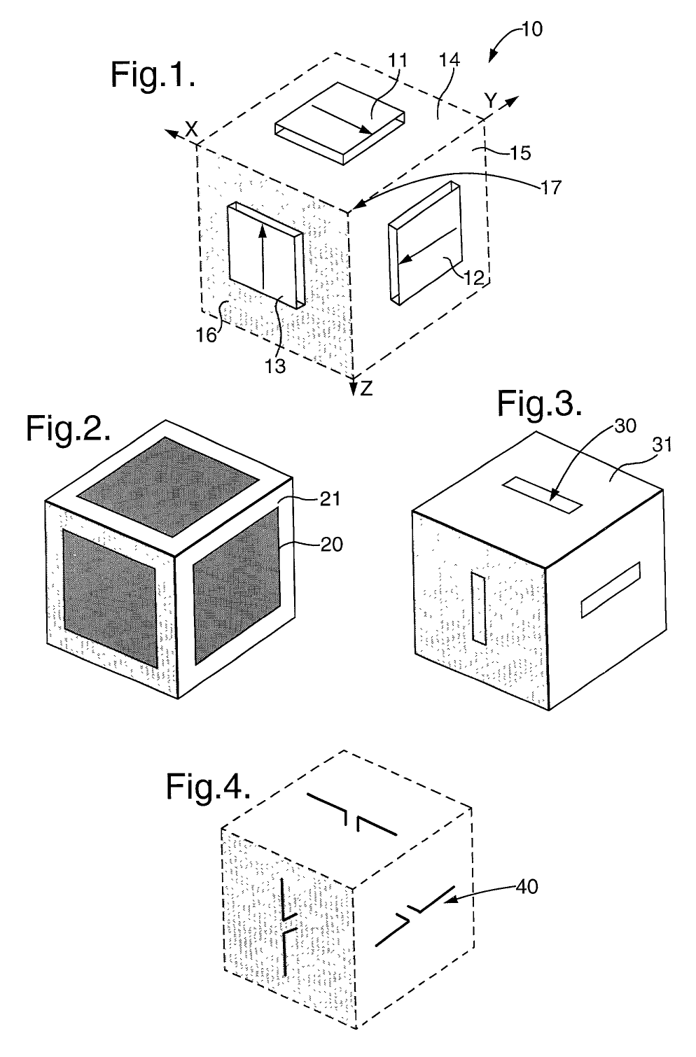

FIG. 1 shows a first example of an antenna array 10. The three planar antenna elements 11, 12, 13 are located on three mutually orthogonal surfaces 14, 15, 16 defining three planes. The adjoining edges of these three surfaces 14, 15, 16 may be considered as lying on a respective axis of a three dimensional XYZ co-ordinate system. A line through the solid angle formed at the intersection of the three planes is defined as the axis 17 of the antenna array.

Each of the planar antennas 11, 12, 13 is linearly polarised. The plane of electrical polarisation of each antenna, respectively, is set parallel to one of the XYZ co-ordinate axes. Thus the three planes of polarisation are mutually orthogonal.

In the example in FIG. 2, the antenna element is a micro-strip patch antenna 20. Again, three linearly polarised patch antennas are mounted orthogonally with respect to each other, with their planes of polarisation each parallel to the adjoining edges. Alternative embodiments employ a radiating slot antenna 30 mounted orthogonally, as shown in FIG. 3, or a dipole antenna 40, as shown in FIG. 4.

For the patch antennas 20 and slot antennas 30 of FIGS. 2 and 3, respectively, the ground planes 21, 31 of these antenna elements may be coupled together at their adjoining edges to form a contiguous conductive surface. This continuity of ground plane enhances the electrical symmetry of the array and so reduces the distortion of the planes of polarisation of the antenna radiation pattern. This reduced distortion improves the electrical isolation between each antenna.

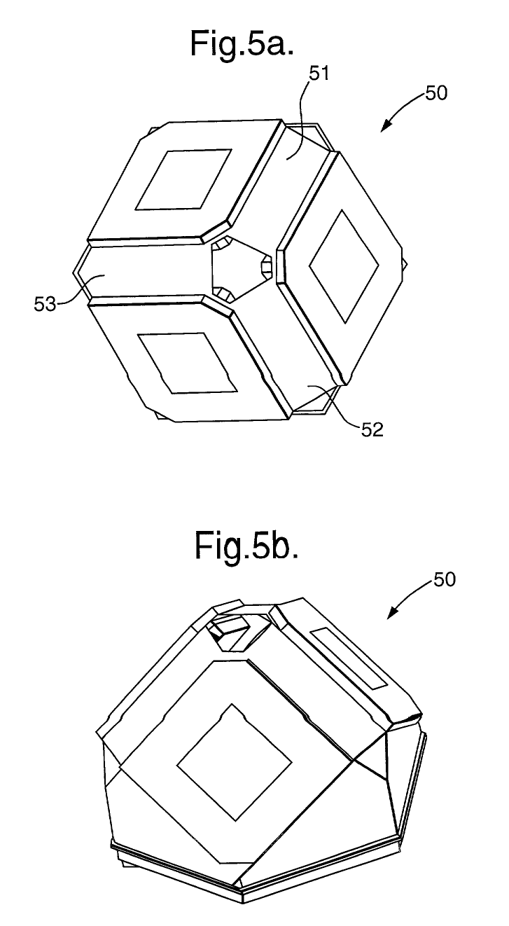

As illustrated in FIGS. 5A and 5B, as a further enhancement to the overall electrical and geometrical symmetry of the antenna structure 50, it is possible to improve further the symmetry of the ground plane structure around each antenna by adding a ground plane 51, 52, 53 around the perimeter. This is inclined at 45 degrees to the plane of the antenna and so permits the assembly to form a closed metal surface, inside which any associated radio electronics may be housed (not shown).

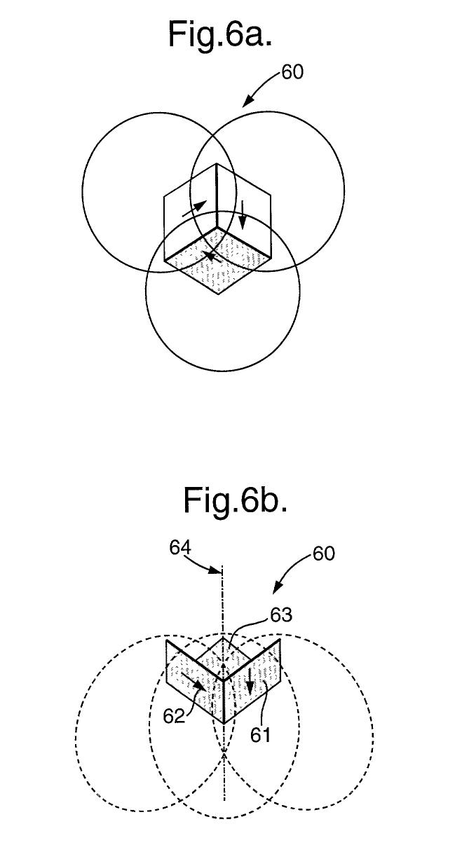

The composite radiation polar diagram of the antenna array 60 will be dependent on the polar diagrams of the individual antenna elements 61, 62, 63, but a typical format is illustrated in FIGS. 6A and 6B. FIG. 6A shows the radiation pattern in the azimuth plane, normal to the array axis 64, whilst FIG. 6B shows the radiation pattern in the elevation plane parallel to the array axis 64. It can be seen in FIG. 6B that the inclination of the three antenna elements 61, 62, 63 to the vertical axis, caused by their orthogonal mechanical orientation, results in a downward inclination of the antenna beams. This feature can be useful in focusing the radiation pattern over a limited geographic area.

The present invention uses the isolation gained from orthogonally polarized antenna elements in three different axes. This is particularly important for Bluetooth applications because antenna isolation is the only method by which it is believed that a number of Bluetooth radios, each in a different piconet, can be successfully collocated. Each antenna element in the design operates independently and sees the other two antenna elements as potential interferers. The advantage of the design is two-fold: The isolation between each element means that three independent Bluetooth radios can be collocated in the array, thus reducing the number of local access devices required; and the unique directional nature of each of the antenna elements (approximately 60° beam width) means that each signal is only transmitted in one direction, thus reducing the level of unwanted interference in other directions and increasing the user density that can be supported.

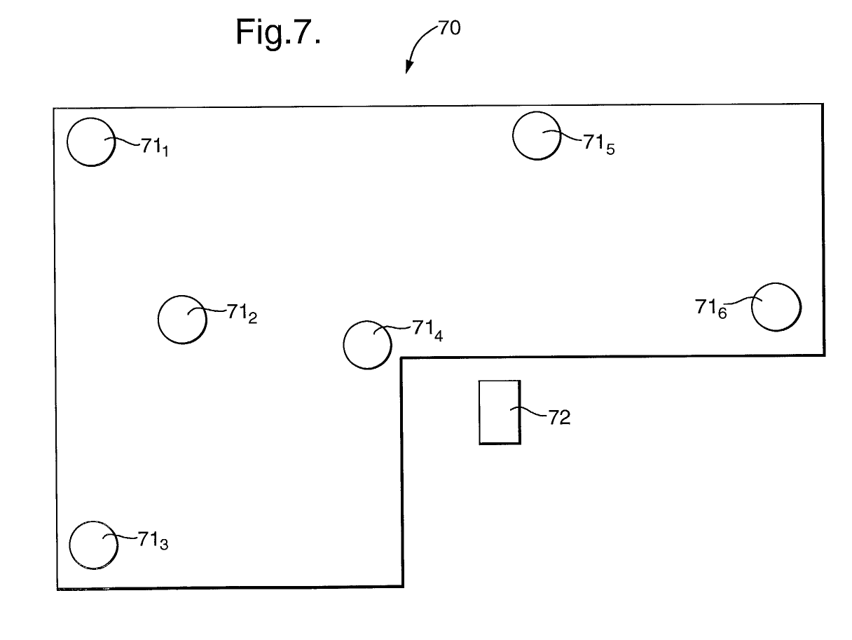

FIG. 7 is an example of a room 70 that is provided with a number of Bluetooth access devices including ceiling mounted antenna arrays 71 in accordance with the present invention to form a Bluetooth-enabled communications network. The Bluetooth access devices 71 are typically coupled to a Bluetooth access server 72 at a remote location using Ethernet connections (not shown). The Bluetooth access devices can be positioned to provide the coverage necessary to support a large number of active Bluetooth devices (not shown) whilst minimising interference at the co-located antennas.

1. An antenna array comprising three surfaces arranged in mutually orthogonal planes, each surface supporting a planar antenna, wherein each antenna is orthogonally polarised with respect to antenna on other surfaces.

2. An antenna array according to claim 1, in which each antenna is linearly polarised to provide a linearly polarised radiation field.

3. An antenna array according to claim 1 or 2, in which the antennas are linearly polarised dipole or mono-pole antennas.

4. An antenna array according to any preceding claim, in which the antennas are selected from a group consisting of transmission line structure antennas, radiating slot structure antennas, and micro-strip patch antennas.

5. A Bluetooth access device comprising an antenna array in accordance with any preceding claim.

6. A radio communications system comprising a plurality of antenna arrays in accordance with any of claims 1 to 4 that are connected to form a communications network.

7. A system according to claim 6, in which each antenna array is configured as a Bluetooth access device.
